(19) United States
(12) Patent Application Publication
(10) Pub. No.: US 2007/0036228 A1
(43) Pub. Date: Feb. 15, 2007

(54) Method and apparatus for audio encoding and decoding

(75) Inventor: Wen-Lung Tseng, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA TECHNOLOGIES INC.

(21) Appl. No.: 11/202,979

(22) Filed: Aug. 12, 2005

(51) Int. Cl. H04B 14/06

(52) U.S. Cl. 375/245

(57) ABSTRACT

An audio encoder for coding an audio bitstream. The side flag is asserted when a first side information and a second side information are the same, a scale flag is asserted when a first scale factor and a second scale factor are the same. A data packer packs a set of variable-length codes into a main data field of the frame, and packs the side flag and the scale flag into an ancillary data field of the frame. The second side information is packed into a side information field of the frame if the side flag of the frame is not asserted, and the second scale factor is packed into the main data field of the frame if the scale flag of the frame is not asserted. An audio decoder is also provided for decoding the encoded audio bitstream generated from the audio encoder.

### BACKGROUND OF THE INVENTION

1. Field of the Invention

The invention relates in general to digital signal processing, and more particularly to the method and apparatus for audio encoding and decoding.

2. Description of the Related Art

Conventionally, analog audio signals are converted to digital audio signals using a pulse code modulation (PCM). Under this system, incoming analog audio signals are fed into an A-D converter to generate digital audio signals, and are then stored in a binary storage. Playback occurs by retrieving the digital signals from the storage and passing them through a D-A converter. By this method, the original true sound is reconstructed.

While sound can be excellent, the problem with PCM audio is that storing the recordings will use up substantial storage space. To better facilitate the audio file transfer across the Internet, the need to minimize file sizes becomes all the more pressing.

Thus, in 1993, the MPEG (Moving Picture Experts Group) committee came up with an efficient encoding method of high-quality audio with reduced size for storage and set out a new standard under ISO/IEC 11172. Through perceptual coding, a psychoacoustic model is used to mask out the range of frequencies of audio that human ears can not perceive. By only storing the frequencies human ears can detect and compressing using Huffman encoding, file sizes are effectively reduced while preserving reasonable audio quality.

It becomes clearer when files sized are presented mathematically. For example, to produce a “CD-quality” sound, a sampling frequency of 44.1 kHz and a resolution of 16 bits per sample are required. Multiplying the two gives 88,200 bytes (with 8 bits to a byte) per second, and twice that for a stereo audio. Thus, for a 3 minute song, it would translate to around 30 megabytes. MP3 encoding, on the other hand, allows the same song to be compressed into one tenth of the size, or 3 megabytes. It was this apparent effectiveness that led MP3 (MPEG layer 3) to become the standard format in music transferring via the Internet.

An MP3 audio encoder generally includes a frame bitstream packing unit, which is used for packing encoded audio samples into audio frames, and each frame contains header information, optional CRC error detection, side information, main data containing Huffman data and a set of scale factors, and an ancillary data. The audio frames have fixed length, with the ancillary data being used for bit aligning.

However, the encoded audio file by this method of MP3 encoding is not compact enough. For example, the ancillary data for bit aligning is a waste in storage space. Also, the way that side information and scale factor are being packed in conventional method does not consider the correlation of the scale factor and side information within audio frames. When it becomes more of a priority to speed up the transmission over internet or to save storage space, a needed approach is to reduce the size of audio files even further.

### SUMMARY OF THE INVENTION

It is therefore an object of the invention to provide an encoder for encoding an audio into an encoded audio bitstream, and the method thereof.

The invention achieves the above-identified object by providing an audio encoder, including an encoding unit, a frame comparison unit, and a bitstream packing unit. The encoding unit codes the audio bitstream and generates a first set of quantized samples with a first set of variable-length codes, a first side information, and a first scale factor, and generating a second set of quantized samples with a second set of variable-length codes, a second side information and a second scale factor.

The frame comparison unit is for asserting a side flag if the first side information and the second side information are the same, and asserting a scale flag if the first scale factor and the second scale factor are the same.

In addition, the bitstream packing unit generates a frame according to the scale flag and the side flag, and the bitstream packing unit includes a data packer, a side information installer, and a scale factor installer.

The data packer is for packing the second set of variable-length codes into a main data field of the frame, and packing the side flag and the scale flag into an ancillary data field of the frame. The ancillary data field contains at least 2 bits for the side flag and the scale flag, respectively.

The side information installer packs the second side information into a side information field of the frame if the side flag of the frame is not asserted. Finally, the scale factor installer is for packing the second scale factor into the main data field of the frame if the scale flag of the frame is not asserted.

According to another object of the invention, an audio decoder is disclosed, for decoding the encoded audio bitstream generated from the audio encoder.

The invention achieves the above-identified object by providing an audio decoder, including a bitstream unpacking unit, and a-decoding unit. The bitstream unpacking unit is for extracting a second frame from an encoded audio bitstream according to a first frame previously extracted, where the second frame comprises an ancillary data field having a side flag and a scale flag, and a main data field having a set of variable-length codes.

The bitstream unpacking unit includes a data extractor, a side information extractor, and a scale factor extractor. The data extractor is for extracting the variable-length codes from the main data field and extracting the side flag and the scale flag from the ancillary data field. In addition, the side information extractor extracts a second side information, in which the second side information is equal to a first side information of the first frame if the scale flag of the second frame is asserted; otherwise, the second side information is extracted from a side information field of the second frame.

The scale factor extractor extracts a second scale factor, in which the second scale factor is equal to the first scale factor if the side flag of the second frame is asserted; otherwise, the scale factor is extracted from the main data field of the second frame. The decoding unit outputs a decoded set of audio samples according to the second side information, the second scale factor, and the variable-length codes.

According to another object of the invention, an audio encoding method is disclosed. The method of audio encoding includes: transforming the audio bitstream from a time domain to a frequency domain and generating a set of subband samples; generating a frequency mask according to the audio bitstream; and receiving the set of subband samples and the frequency mask for outputting a first set of quantized samples with a first side information and a first scale factor and a second set of quantized samples with a second side information and a second scale factor.

According to another object of the invention, an audio decoding method is disclosed. The method of decoding includes: extracting a set of variable-length codes from a main data field of a second frame, and extracting a side flag and a scale flag from an ancillary data field of the second frame; according to a first frame previously extracted, extracting a second side information, which equals to a first side information of the first frame if the scale flag of the second frame is asserted, else extracting the second side information from a side information field of the second frame; and extracting the second scale factor, which equals to the first scale factor if the side flag of the second frame is asserted, else extracting the second scale factor from a main data field of the second frame; and receiving the second side information, the second scale factor, and the variable-length codes for outputting a decoded set of audio samples

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a diagram illustrating a conventional audio frame in an encoded audio bitstream.

FIG. 2 is a block diagram illustrating an audio encoder according to the preferred embodiment of the invention.

FIG. 3 shows block diagram illustrating an audio decoder according to the preferred embodiment of the invention.

FIG. 4 shows a graph of the size-reduced ratio of an audio bitstream according to the preferred embodiment.

### DETAILED DESCRIPTION OF THE INVENTION

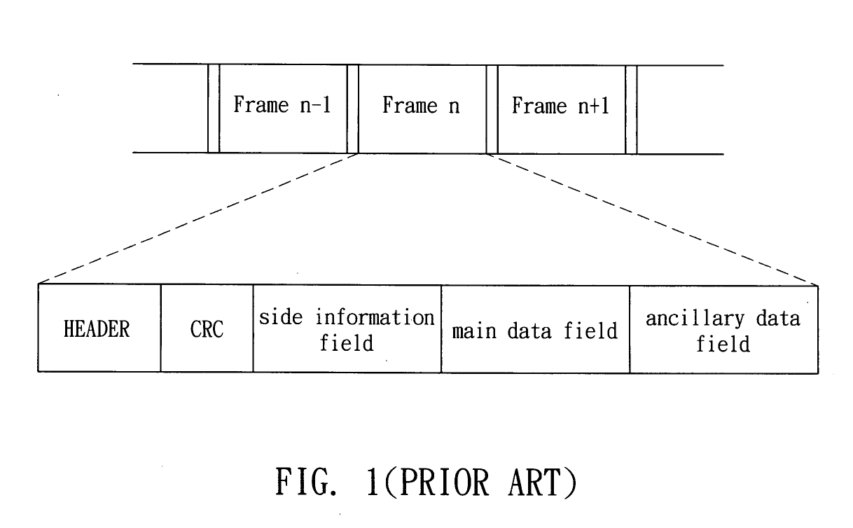

FIG. 1 is a block diagram illustrating a conventional audio frame in an encoded audio bitstream. The audio frame includes a header, a CRC field, a side Information field, a main data field and an ancillary data field. The header includes the first 32 bits of information of the audio frame. The CRC includes a 16 bits parity-check data used for error detection. The main data field includes variable-length codes, such as Huffman encoded data, and the scale factor for reconstruction. The side information field includes side information for decoding the variable-length codes in the main data field. The ancillary data field includes data for alignment. Each of the conventional frames of the encoded audio stream stores the side information and the scale factor, however, the side information and the scale factors may be the same in the adjoining frames and thus the encoded audio stream is not compact.

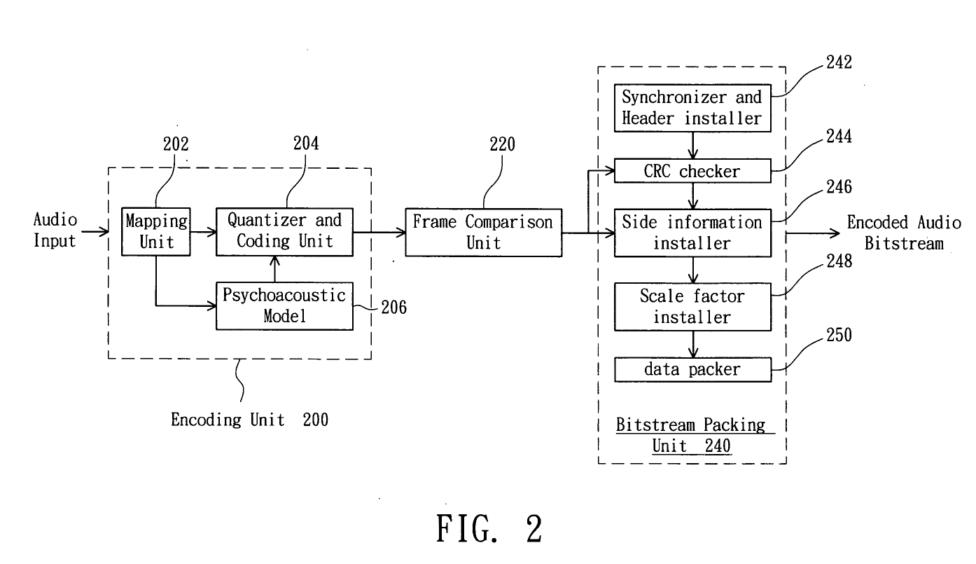

FIG. 2 is a block diagram illustrating an audio encoder according to the preferred embodiment of the invention. The audio encoder generates the encoded audio bitstream without redundant side information and scale factors, and includes an encoding unit 200, a frame comparison unit 220, and a bitstream packing unit 240. The encoding unit 200 includes a mapping unit 202, a quantizer and coding unit 204, and a psychoacoustic model 206. The mapping unit 202 has an input for receiving an audio bitstream, such as a PCM (pulse code modulation) audio. The encoding unit 200 codes the audio bitstream such as by Huffman algorithm, and generates encoded data, such as a first set of quantized samples with a first set of variable-length codes, a first side information, and a first scale factor, and a second set of quantized samples with a second set of variable-length codes, a second side information and a second scale factor, wherein the first set of quantized samples is previous to the second set of quantized samples.

The frame comparison unit 220 is connected to encoding unit 200. According to the first and second set of quantized samples, frame comparison unit 220 asserts a side flag when the first side information and the second side information are the same. Similarly, frame comparison unit 220 asserts a scale flag when the first scale factor and the second scale factor are the same.

Bitstream packing unit 240 is connected to encoding unit 200 and frame comparison unit 220. Bitstream packing unit 240 receives both the side and scale flags from frame comparison unit 220 and the first and second set of quantized samples from the encoding unit 200, and generates and outputs at least a frame. A series of frames constitutes the encoded audio bitstream or the encoded audio file. Side information installer 246 is connected to frame comparison unit 220 and the output of CRC checker 244, for packing the side information into the side information field of the frame if the side flag is not asserted. Scale factor installer 248 also connects to frame comparison unit 220, for packing the second scale factor into the main data field if the scale flag is not asserted. Data packer 250 is connected to the scale factor installer 248, and packs the second set of variable-length codes into a main data filed of the frame, and packs the side flag and the scale flag into an ancillary data field of the frame, where ancillary data field contains at least 2 bits for the side flag and the scale flag. It should be noted that the sequence of CRC checker 244, side information installer 246, scale factor installer 248 and data packer 250 can be altered by the people skilled in the art to perform the same function.

In addition, before the encoding unit 200 can generate the quantized samples, mapping unit 202, quantizer and coding unit 204, and psychoacoustic model 206 need to perform a few tasks. That is, mapping unit 202 has an input for receiving the audio bitstream, and transforms the audio bitstream from a time domain to a frequency domain using mathematical algorithms such as fast Fourier transform (FFT), and generates a set of subband samples. In some embodiments, the mapping function also employs a variation of the fast Fourier transform (FFT) or the discrete cosine transformation (DCT) in order to obtain higher frequency resolution. The psychoacoustic model 206 also has an input to receive the audio bitstream, and generates a frequency mask according the audio bitstream.

The quantizer and coding unit 204 is connected to both mapping unit 202 and psychoacoustic model 206, in which the quantizer and coding unit 204 produces the first and second set of variable-length codes according to the subband samples and the frequency mask of the second set of. Being connected to the output of mapping unit 202 and psychoacoustic model 206, quantizer and coding unit 204 outputs the first set of quantized samples the second set of quantized samples

As illustrated by the encoder according to the preferred embodiment of the invention, the frame comparison unit 140 is introduced to make use of the ancillary data that contains the side flag and the scale flag. That is, by comparing the side information and scale factor with that of the previous frame to assert flags during encoding, no redundant side information and scale factors are packed in the encoded audio bitstream during bitstream packing 150. Therefore, the size of frame can be reduced, and as a result, the size of the overall encoded audio bitstream can be effectively reduced.

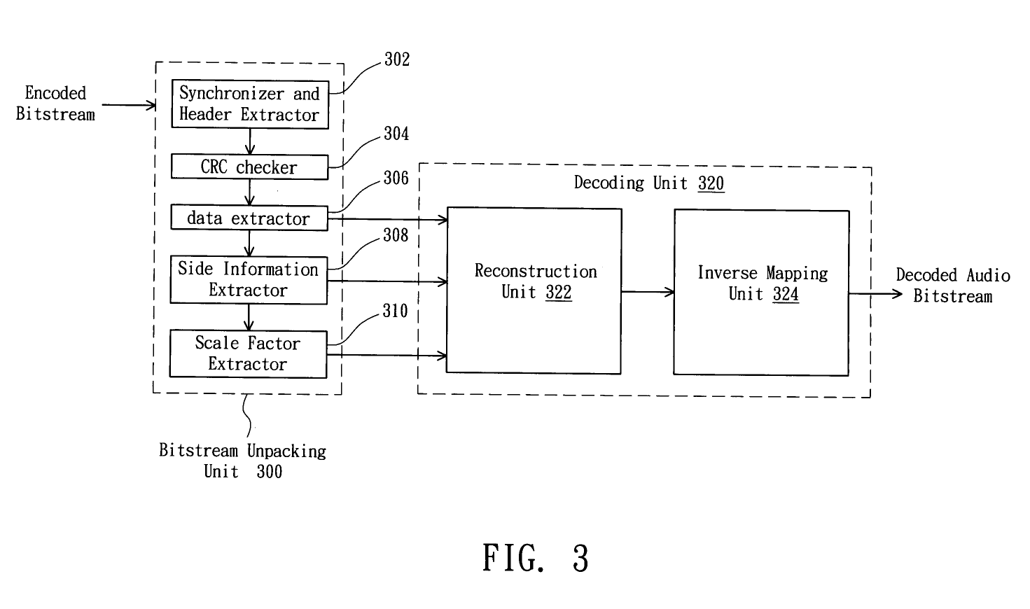

FIG. 3 shows a block diagram illustrating an audio decoder according to the preferred embodiment of the invention. The audio decoder includes a bitstream packing unit 300, and a decoding unit 320. Bitstream unpacking unit 300 is used to extract frames, for example, a second frame which follows the first frame, from the encoded audio bitstream generated by the encoder described above. Each frame includes an ancillary data field having a side flag and a scale flag and a main data field having a set of variable-length codes such as Huffman codes. In addition, the bitstream unpacking unit 300 includes a synchronization and header extractor 302, a CRC checker 304, a data extractor 306, a side information extractor 308, and a scale factor extractor 310. Synchronizer and header extractor 302 is used to synchronize and find header information of the frames. And CRC checker 304, checks for errors in the frames if being enabled.

After the first frame is extracted, the second frame is extracted according to the first frame. Data extractor 306 extracts the variable-length codes from the main data field of the second frame, and extracting the side flag and the scale flag from the ancillary data field of the second frame. Side information extractor 308 is connected to data extractor 306, for extracting a second side information, wherein the second side information is equal to the first side information of the first frame if the scale flag of the second frame is asserted, else extracting the second side information from a side information field of the second frame. Scale factor extractor 310 is connected to the scale factor, for extracting a second scale factor, wherein the second scale factor is equal to the first scale factor if the side flag of the second frame is asserted, else extracting the scale factor from the main data field of the second frame. Decoding unit 320 is connected to the bitstream unpacking unit 300. And the decoding unit receives the second side information, the second scale factor, and the variable-length codes from encoding unit 300 for outputting a decoded set of audio samples.

Decoding unit 320 includes a reconstruction unit 322 and an inverse mapping unit 324. Reconstruction unit 322 is used for decoding the variable-length codes and outputting a set of subband samples according to the decoded variable-length codes, the second side information and the second scale factor. Next, inverse mapping unit is connected to the output of reconstruction unit 322, and is for inverse mapping the subband samples from a frequency domain to a time domain, and for outputting the decoded set of audio samples.

Through using the bitstream unpacking unit 300, and with the aid of the scale and side flags, it is demonstrated from above preferred embodiment that the size-reduced encoded audio bitstream can be effectively decoded with the audio decoder of the embodiment.

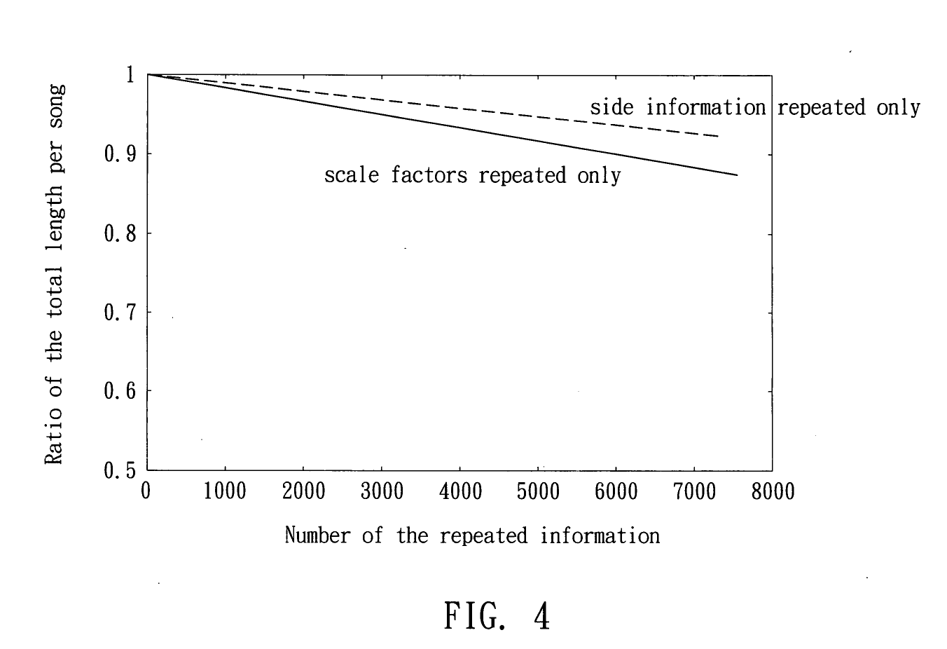

To better illustrate the effects of the invention, FIG. 4 shows a graph of the size-reduced ratio of an encoded audio bitstream according to the preferred embodiment. The horizontal axis represents the number of times scale factor and side information are repeated in an audio bitstream, and the vertical axis represents the reduction of the encoded audio bitstream of the embodiment, and is marked on the graph as the ratio of the total length per song. In the embodiment, the repeated probability of the side information and the scale factors in each frame are assumed to be independent, and the average length of the side information and scale factors in a dual channel format are 32 bytes and 54 bytes respectively. It is also assumed that the total length of an encoded audio bitstream is 3 MB, and has a bit rate of 128 kbps, and a sampling frequency of 44.1 kHz. The size of each frame is then derived to be equal to 418 byte using the equation:
Frame Size=(Bit Rate/Sampling Frequency)*1152 (equation 1)
Thus, given a 3 MB length of audio, and knowing that there is 418 bytes per frame, the number of frames in an audio is calculated to be around 7200 frames, which translates to the maximum limit of the horizontal axis as seen on FIG. 4, or more precisely, the side information or the scale factor can be at most repeated 7200 times.

As indicated graphically, the top and the bottoms lines, representing the repetition of side information and of scale factors, respectively, reveal that as the number of times the side information and scale factor that are repeated increases, the length of an audio file effectively decreases.

Thus, as it has been shown, the invention effectively reduces the size of an encoded audio bitstream by the method as described. In fact, the reduction is up to 13% if compared to the length of a MP3 format audio bitstream.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An audio encoder, comprising:
an encoding unit, for coding an audio bitstream and generating a first set of quantized samples with a first set of variable-length codes, a first side information, and a first scale factor, and generating a second set of quantized samples with a second set of variable-length codes, a second side information and a second scale factor;
a frame comparison unit, for asserting a side flag while the first side information and the second side information being the same, and asserting a scale flag while the first scale factor and the second scale factor being the same; and
a bitstream packing unit, for generating a frame according to the scale flag and the side flag, the bitstream packing unit comprising;
a data packer, for packing the second set of variable-length codes into a main data field of the frame, and packing the side flag and the scale flag into an ancillary data field of the frame;
a side information installer, for packing the second side information into a side information field of the frame if the side flag of the frame is not asserted; and
a scale factor installer, for packing the second scale factor into the main data field of the frame if the scale flag of the frame is not asserted.

2. The audio encoder according to claim 1, wherein the ancillary data field contains at least 2 bits for the side flag and the scale flag, respectively.

3. The audio encoder according to claim 1, wherein the encoding unit comprises^{□} a mapping unit, for transforming the audio bitstream from a time domain to a frequency domain and generating a set of subband samples;
a psychoacoustic model, for generating a frequency mask according to the audio bitstream; and
a quantizer and coding unit, generating the first and second set of variable-length codes according to the subband samples and the frequency mask, and outputting the first set of quantized samples and the second set of quantized samples.

4. The audio encoder according to claim 1, wherein the bitstream packing unit further comprises:
a synchronizer and header installer, for synchronizing the frame; and
a CRC checker, if enabled, for checking errors in the frame.

5. The audio encoder according to claim 1, wherein the first set and the second set of variable-length codes are Huffman codes.

6. An audio decoder, comprising:
a bitstream unpacking unit, for extracting a second frame from an encoded audio bitstream according to a first frame previously extracted, wherein the second frame comprises an ancillary data field having a side flag and a scale flag, and a main data field having a set of variable-length codes, the bitstream unpacking unit comprises:
a data extractor, for extracting the variable-length codes from the main data field and extracting the side flag and the scale flag from the ancillary data field;
a side information extractor, for extracting a second side information, wherein the second side information is equal to a first side information of the first frame if the side flag of the second frame is asserted, else extracting the second side information from a side information field of the second frame; and
a scale factor extractor, for extracting a second scale factor, wherein the second scale factor is equal to the first scale factor if the scale flag of the second frame is asserted, else extracting the scale factor from the main data field of the second frame; and
a decoding unit, receiving the second side information, the second scale factor, and the variable-length codes for outputting a decoded set of audio samples.

7. The audio decoder according claim 6, wherein the decoding unit comprises:
a reconstruction unit, decoding the variable-length codes, and outputting a set of subband samples according to the decoded variable-length codes, the second side information and the second scale factor; and
an inverse mapping unit, for inverse mapping the subband samples from a frequency domain to a time domain, and outputting the decoded set of audio samples.

8. The audio decoder according to claim 6, wherein the bitstream unpacking unit further comprises:
a synchronizer and header installer, for synchronizing and finding header information of the first and second frame; and
a CRC checker, if enabled, for checking errors in the first and second frame.

9. The audio decoder according to claim 6, wherein the variable-length codes are Huffman codes.

10. A method of encoding an audio bitstream, comprising:
coding the audio bitstream and generating a first set of quantized samples with a first set of variable-length codes, a first side information and a first scale factor, and generating a second set of quantized samples with a second set of variable-length codes, a second side information and a second scale factor;
asserting a side flag while the first side information and the second side information being the same;
asserting a scale flag while the first scale factor and the second scale factor being the same; and
generating a frame according to the scale flag and the side flag, comprising:
packing the variable-length codes from the second set of quantized samples into a main data field of the frame, and packing the side flag and the scale flag into an ancillary data field of the frame;
packing the second side information into a side information field of the frame if the side flag of the second frame is not asserted; and
packing the second scale factor into the main data field of the frame if the scale flag of the second frame is not asserted.

11. The method of encoding an audio bitstream according to claim 10, wherein the coding the audio bitstream step comprises:
transforming the audio bitstream from a time domain to a frequency domain and generating a set of subband samples;
generating a frequency mask according to the audio bitstream; and
receiving the set of subband samples and the frequency mask for outputting a first set of quantized samples with a first side information and a first scale factor and a second set of quantized samples with a second side information and a second scale factor.

12. The method of encoding an audio bitstream according to claim 10, wherein the method of encoding an audio bitstream further comprises:
synchronizing and finding header information of the frame; and
checking for errors in the frame if a CRC checker is enabled.

13. A method of decoding an encoded audio bitstream, comprising:
extracting a set of variable-length codes from a main data field of a second frame, and extracting a side flag and a scale flag from an ancillary data field of the second frame;
according to a first frame previously extracted, extracting a second side information, which equals to a first side information of the first frame if the side flag of the second frame is asserted, else extracting the second side information from a side information field of the second frame; and
extracting the second scale factor, which equals to the first scale factor if the scale flag of the second frame is asserted, else extracting the second scale factor from a main data field of the second frame; and
receiving the second side information, the second scale factor, and the variable-length codes for outputting a decoded set of audio samples

14. The method of decoding the audio bitstream according to claim 13, wherein the method of decoding the audio bitstream further comprises:
synchronizing and finding header information of the first and second frame; and
checking for errors in the first and second frame if a CRC checker is enabled.

15. The method of decoding the audio bitstream according to claim 13, wherein the variable-length codes are Huffman codes.
